(19) United States
(12) Patent Application Publication
(10) Pub. No.: US 2008/0082806 A1
(43) Pub. Date: Apr. 3, 2008

(54) Cache controller, microprocessor system, and storage device

(75) Inventor: Osamu Yoshida, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/711,233

(22) Filed: Feb. 27, 2007

(30) Foreign Application Priority Data
Sep. 29, 2006 (JP) 2006-268966

(51) Int. Cl. G06F 9/22

(52) U.S. Cl. 712/237; 712/E09.004

(57) ABSTRACT

A cache controller prefetches instruction code from a memory and stores the instruction code in a cache. The cache controller comprises an address output section for, when an instruction fetch address from a processor is matched with a comparative address, outputting a prefetch address corresponding to the comparative address, and a load control section for loading the instruction code in the cache from the outputted prefetch address of the memory.

### BACKGROUND OF THE INVENTION

1. Field of the Invention

The present invention relates to a cache controller with the function of storing a part of instruction code in a cache, and also relates to a microprocessor system and a storage device each employing the cache controller.

2. Description of the Related Art

Among programs for disk devices, a boot program is generally installed in a nonvolatile memory. After power-on, therefore, programs other than the boot program are read from a disk medium by using the boot program written in the nonvolatile memory. The program read from the disk medium is temporarily stored in a memory formed of a DRAM (Dynamic Random Access Memory) having a slow access speed. Also, a part of the read program is stored in a SRAM (Static Random Access Memory) having a fast access speed, which serves as a cache. Transfer of the program from the memory to the cache is controlled by a cache controller. The instruction code of the program stored in the cache is fetched by an MPU (Micro Processing Unit). The cache is constituted, for example, by two stages of caches, i.e., a cache A and a cache B. In some of programs, the instruction code includes no branch instructions. In the case of such a program, when the MPU executes a part of the program stored in the cache A and the fetch position of the instruction code reaches a predetermined size in the cache A, instruction code of another part of the program subsequent to the program stored in the cache A is stored in the cache B from the memory. Stated another way, when the program has the instruction code including no branch instructions, the instruction code scheduled to be executed in time ahead can be continuously prefetched from the memory to the cache with the above-described cache function, thus resulting in a less probability of false fetch of the instruction code into the cache, which is caused by a cache error. As a result, a processing time for execution of the program can be shortened.

In other cases, however, when the MPU fetches the instruction code in the cache A, for example, the fetched instruction code may be, e.g., a subroutine call instruction as one of branch instructions. In that case, the cache controller determines whether the instruction code of a subroutine to be called is present in the cache A or B. If the instruction code is not found in any of the caches, this is determined to be a cache error and the instruction code of the subroutine is stored in the cache B from the memory. Also, if the size of the instruction code of the subroutine is larger than the cache size, an excessive-part of the instruction code of a subroutine program is stored in the cache A during the execution of the subroutine. When processing of the subroutine is completed later, the instruction code for the return destination of the subroutine has already been excluded from the cache A and another code is cached therein. This is determined to be a cache error and the instruction code for the return destination of the subroutine is required to be cached again. Such re-transfer of the instruction code into the cache from the memory imposes an extra load on the memory and affects the program execution time. Japanese Unexamined Patent Application Publication No. 11-143775 discloses a method of updating a cache prior to fetch of an instruction code requiring update of the cache.

According to the proposed method, a program instruction described by a user is used to cause a command register within a cache controller, which is mapped on a memory, to execute a transfer instruction for writing data. The cache controller obtains, based on the contents of the command register, head one of addresses at which the data is stored. Then, the cache controller drives a DMAC (Direct Memory Access Control) to store the data in the cache from the memory. As a result, a cache hit can be increased with the process that a user describes, on a program, places where the cache is to be updated. However, the proposed method requires the user to describe, on the program, the instruction code for all the places where the cache is to be updated, and therefore affects volume of the entire program.

### SUMMARY OF THE INVENTION

An object of the present invention is to provide a cache controller which updates a cache in advance without adding instruction code to a program, and to provide a microprocessor system and a storage device each employing the cache controller.

In the cache controller, the microprocessor system and the storage device according to the present invention, for prefetching instruction code from a memory and storing the instruction code in a cache, the cache controller comprises an address output section for, when an instruction fetch address from a processor is matched with a predetermined address, outputting a prefetch address corresponding to the predetermined address; and a load control section for loading the instruction code in the cache from the outputted prefetch address. With such an arrangement, since the prefetch address corresponding to the predetermined address is outputted, the probability of a cache error is reduced in an instruction fetch cycle executed by an MPU.

### BRIEF DESCRIPTION OF THE DRAWINGS

FIG. 1 is a block diagram showing an internal structure of a hard disk device;

FIG. 2 is a block diagram of a microprocessor system;

FIG. 3 is a block diagram for explaining an address output section;

FIGS. 4A and 4B are illustrations for explaining tables;

FIG. 5 is an illustration for explaining an address space;

FIGS. 6A-6C are illustrations for explaining, as a first part, a subroutine operation;

FIGS. 7A-7C are illustrations for explaining, as a second part, the subroutine-operation; and

FIG. 8 is, an illustration for explaining, as a third part, the subroutine operation.

### DESCRIPTION OF THE PREFERRED EMBODIMENTS

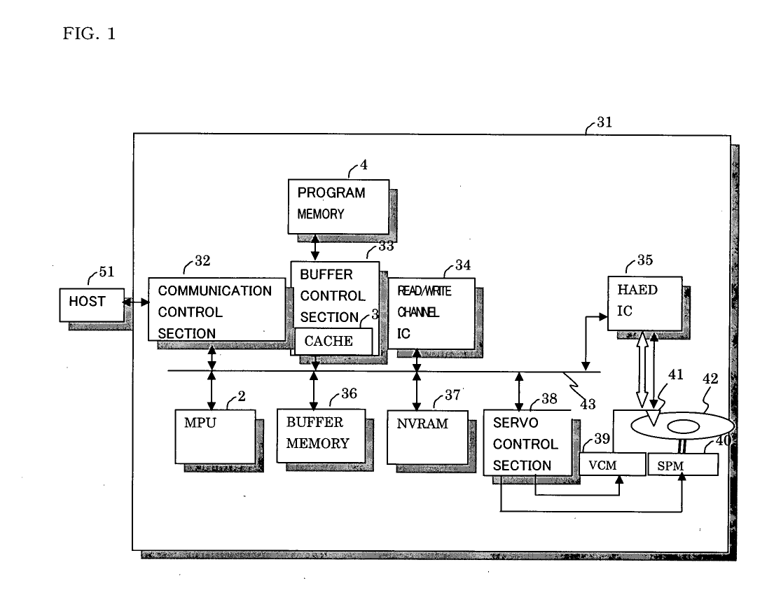

FIG. 1 is a block diagram showing an internal structure of a hard disk device. A hard disk device 31 comprises a communication control section 32 for controlling an interface between the hard disk device and a host 51, a program memory 4 for storing a program, a buffer control section 33 for controlling a cache 3, etc., a read/write channel IC 34 for executing code modulation of write data and code demodulation of read data, a head IC 35 incorporating a read amplifier and a write driver, an MPU 2, a buffer memory 36 for storing data, a nonvolatile memory (NVRAM) 37 for storing a boot program, a servo control section 38 for controlling rotation of a disk medium 42 and operation of a head actuator, a voice coil motor (VCM) 39 for actually moving the head actuator, a spindle motor (SPM) 40 for rotating the disk medium 42, a head 41 for performing read/write, the disk medium 42, and an internal common bus 43. The program memory 4 and the buffer control section 33 are connected to each other by a locus bus. Write data from the host 51 is stored in the buffer memory 36 via the communication control section 32. The stored write data is subjected to the code modulation in the read/write channel IC 34 and is written on the disk medium 42 by the head IC 35 through the head 41. Data read from the disk medium 42 by the head 41 is stored in the buffer memory 36 after being amplified by the head IC 35 and being subjected to the code demodulation in the read/write channel IC 34. The stored data is transmitted to the host 51 from the communication control section 32.

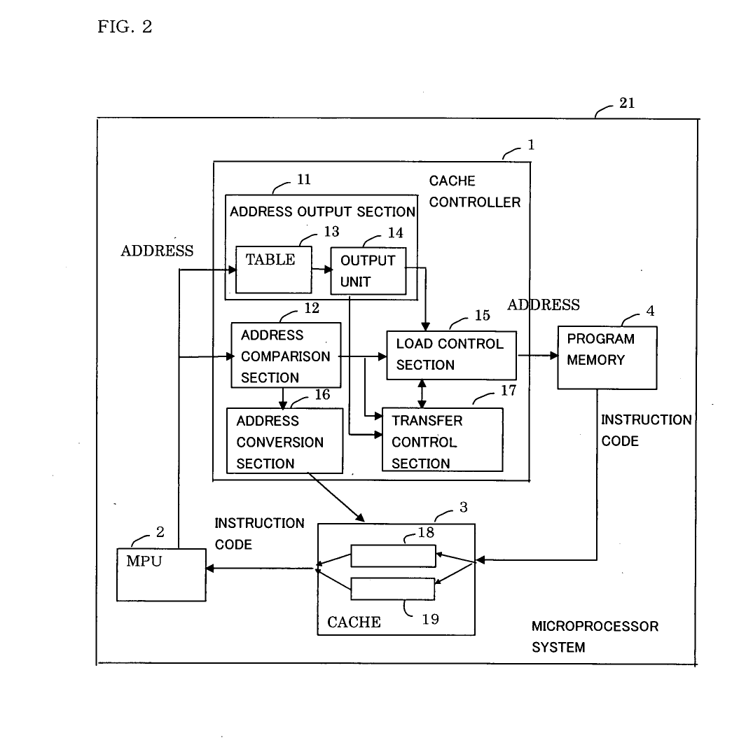

FIG. 2 is a block diagram of a microprocessor system. A microprocessor system 21 comprises a cache controller 1, an MPU 2, a cache 3, and a program memory 4. The cache controller 1 controls the cache 3. The MPU 2 is a microprocessor which fetches instruction code from the cache 3 and executes the fetched instruction code. The cache 3 is a SRAM which temporarily stores the instruction code. The cache 3 is made up of two caches 18 and 19. Each of the cache 18 and the cache 19 has capacity of, e.g., 64 bytes. The program memory 4 is a SDRAM (Synchronous DRAM) which stores the program for operating the hard disk device 31. The cache controller 1 comprises an address output section 11, an address comparison section 12, a load control section 15, an address conversion section 16, and a transfer control section 17. The address comparison section 12 determines whether a fetch address outputted from the MPU 2 to fetch the instruction code is within the range of instruction-code storage addresses in the cache 3. If so, a cache hit signal is outputted, and if not so, a cache error signal is outputted along with the fetch address. To that end, in the address comparison section 12, addresses used for comparison with the instruction-code fetch address outputted from the MPU 2 are stored in address registers A-D (not shown). Of the address registers A-D, the address register A stores a head address of the instruction code stored in the cache 18, and the address register B stores a final address thereof. Also, the address register C stores a head address of the instruction code stored in the cache 19, and the address register D stores a final address thereof. Accordingly, the address comparison section 12 determines whether the fetch address for the cache 3 is included within the address range from the address stored in the address register A to the address stored in the address register B. Also, the address comparison section 12 determines whether the fetch address for the cache 3 is included within the address range from the address stored in the address register C to the address stored in the address register D.

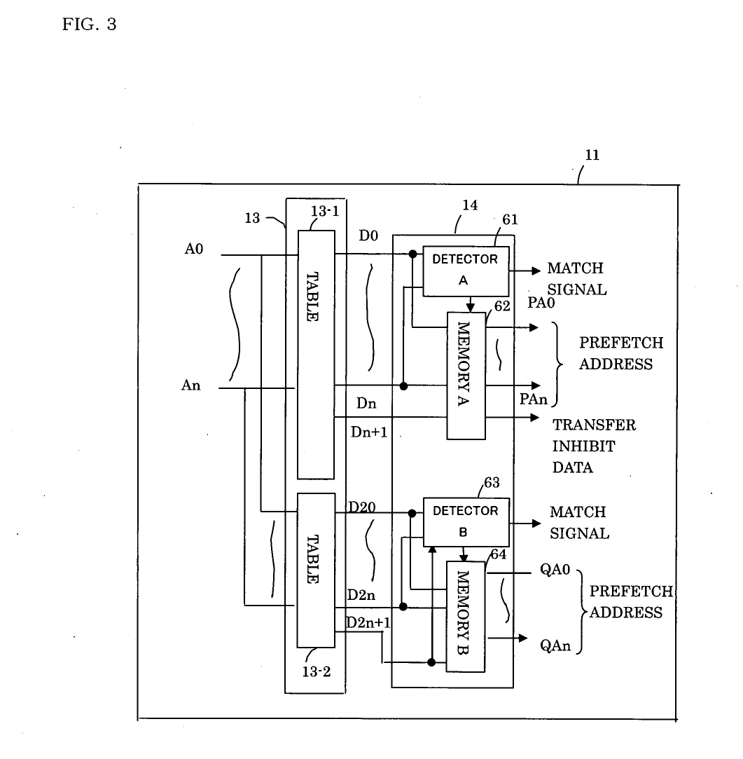

FIG. 3 is a block diagram for explaining the address output section. The address output section 11 comprises a table 13 and an output unit 14. The table 13 represents the correspondence between a load start address at which is started loading of a specified program into the cache 3 and an address at which is stored the specified program. The table 13 is made up of two tables 13-1 and 13-2. The table 13-1 serves as a table for storing a storage address of a subroutine in the program memory 4. The table 13-1 serves also as a table for, when the subroutine includes only one return destination address, storing the return destination address. The table 13-2 serves as a table for designating a plurality of return destination addresses of the subroutine. The output unit 14 outputs a prefetch address, a match signal, and transfer inhibit data with respect to addresses outputted from the table 13.

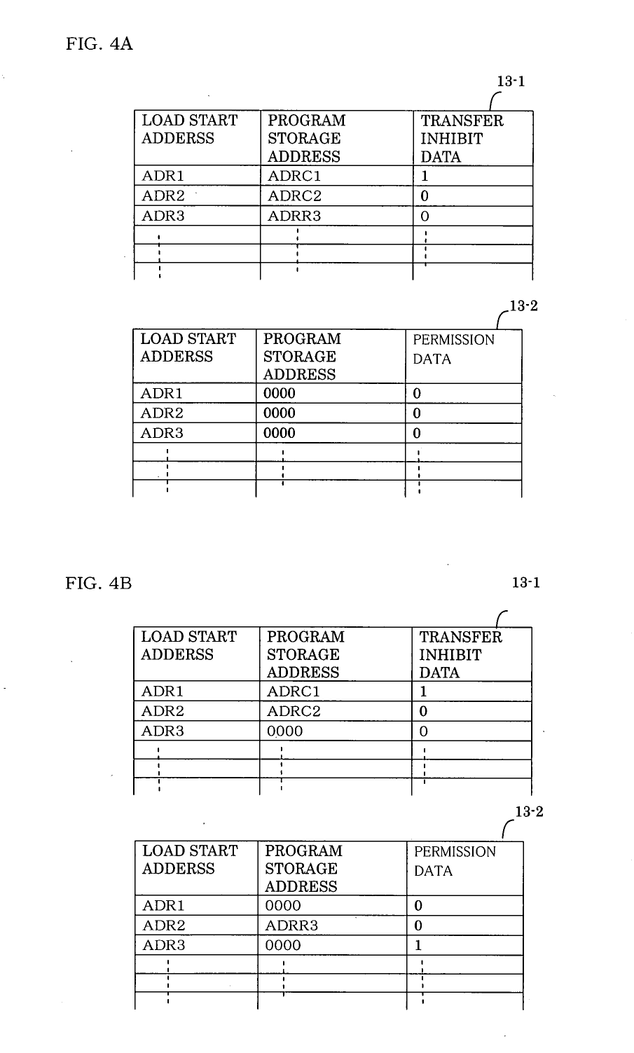

FIGS. 4A and 4B are illustrations for explaining the tables. FIG. 4A represents the case where the same subroutine is used at only one point in the program. FIG. 4B represents the case where the same subroutine is used at a plurality of points in the program. The table 13-1 represents the correspondence between a load start address at which is started transfer from the program memory 4 to the cache 3 and a program storage address at which is stored a predetermined program. When the fetch address from the MPU 2 and the load start address are matched with each other, the program storage address corresponding to the load start address is outputted as the prefetch address. When “0000” in hexadecimal notation is stored as the program storage address, this indicates that the prefetch address is not outputted. The table 13-1 also represents the correspondence between the load start address and the transfer inhibit data. When the transfer inhibit data is “1”, the transfer is inhibited, and when it is “0”, the transfer is permitted. The transfer inhibit data is prepared with intent to, when the cache 3 is called after storing the subroutine in the cache 3 in accordance with the load start address, automatically inhibit the cache 3 on the calling side from fetching the program from the program memory 4. The transfer inhibit data is used when the subroutine has volume smaller than the capacity of the cache 3.

On the other hand, the table 13-2 represents the correspondence between the load start address at which is started transfer from the program memory 4 to the cache 3 and the program storage address at which is stored the predetermined program. When the fetch address from the MPU 2 is matched with the load start address, the program storage address corresponding to the load start address is outputted. The outputted program storage address is stored in a memory B 64 of the output unit 14. When “0000” in hexadecimal notation is stored as the program storage address, this indicates that the prefetch address is not outputted. The table 13-2 also represents the correspondence between the load start address and permission data. When the permission data is “1”, the prefetch address is obtained from the memory B 64 of the output unit 14 and is outputted. Meanwhile, when it is “0”, the prefetch address is not obtained from the memory B 64.

Returning to FIG. 3, the table 13 is first described in connection with an example of FIG. 4A. In this example, the same subroutine is used at only one point in the program. Upon inputting of a fetch address A0-An from the MPU 2, when the input address is a load start address ADR1 or ADR2 for storage of the subroutine program into the cache 3, the table 13-1 outputs data D0-Dn of a prefetch address ADRC1 or ADRC2 for the corresponding subroutine and the transfer inhibit data Dn+1. Also, upon inputting of the fetch address A0-An from the MPU 2, when the input address is a load start address ADR3 for storage of the program subsequent to a return destination address of the subroutine into the cache 3, the table 13-1 outputs data D0-Dn of a prefetch address ADRR3 for the corresponding subroutine and the transfer inhibit data Dn+1.

The output unit 14 includes a detector A 61 outputting a mismatch signal when an output resulted from accessing the table 13-1 is “0000”, and a match signal if otherwise. Further, when the detector A 61 outputs the match signal, the data D0-Dn+1 is latched in a memory A 62. The latched data is outputted as a prefetch address PA0-PAn and the transfer inhibit data along with the match signal. On the other hand, because “0000” is stored as the program storage address in the tables 13-2, “0000” is outputted as D20-D2n and a detector B 63 in the output unit 14 determines a mismatch. As a result, no data is stored in the memory B 64 of the output unit 14. Hence a prefetch address QA0-QAn is not outputted. Further, because the permission data D2n+1 is “0”, the prefetch address is not obtained from the memory B 64.

The table 13 is now described in connection with an example of FIG. 4B. In this example, the same subroutine is used at a plurality of points in the program. Upon inputting of a fetch address A0-An from the MPU 2, when the input address is the load start address ADR1 or ADR2 for storage of the subroutine program into the cache 3, the table 13-1 outputs the data D0-Dn of the prefetch address ADRC1 or ADRC2 for the corresponding subroutine and the transfer inhibit data Dn+1. Also, upon inputting of the fetch address A0-An from the MPU 2, when the input address is the load start address ADR3 for storage of the program subsequent to the return destination address of the subroutine into the cache 3, the table 13-1 outputs “0000”. The output unit 14 includes a detector A 61 outputting a mismatch signal when an output resulted from accessing the table 13-1 is “0000”, and a match signal if otherwise. Further, when the detector A 61 outputs the match signal, the data D0-Dn+1 is latched in the memory A 62. The latched data is outputted as the prefetch address PA0-PAn and the transfer inhibit data along with the match signal.

On the other hand, upon inputting of the fetch address A0-An from the MPU 2, when the input address is the load start address ADR1 or ADR2 for storage of the subroutine program into the cache 3, the table 13-2 outputs “0000” or data D20-D2n of ADRR3 (return destination address of the subroutine) correspondingly. The permission data D2n+1 is “0”. Also, upon inputting of the fetch address A0-An from the MPU 2, when the input address is the load start address ADR3 for storage of the program subsequent to the return destination address of the subroutine into the cache 3, the table 13-1 outputs “0000” while it outputs “1” as the permission data D2n+1.

The output unit 14 includes the detector B 63 outputting a mismatch signal when an output resulted from accessing the table 13-2 is “0000”, and a match signal if otherwise. When the load start address is ADR2, the match signal is outputted and the return destination address ADRR3 of the subroutine, which is outputted as D20-D2n, is stored in the memory B 64. Further, when the permission data D2n+1 is “1”, the output unit 14 outputs, as the prefetch address QA0-QAn, the return destination address ADRR3 of the subroutine, which is stored in the memory B 64. At the same time, the output unit 14 outputs the match signal. The match signal is generated by the detector B 63 based on the permission data. Thus, when the same subroutine is used at a plurality of points in the program, the return destination address of the subroutine corresponding to the load start address for each of those points in the program can be previously set in the table 13-2. Further, when the load start address is detected in the subroutine, the return destination address of the subroutine corresponding to each of those points can be outputted from the memory B 64. The memory B 64 has a FIFO structure to be adaptable for the case where one subroutine includes another subroutine. Additionally, the load start address is decided as follows. First, the user looks for an unconditional branch instruction or a return instruction. Then, if the unconditional branch instruction or the return instruction is found, an address preceding a fixed number of bytes from the address of the found instruction is decided. Finally, the decided address is obtained as the load start address.

Returning to FIG. 2, the load control section 15 includes a cache start register indicating a start address for transfer of the program instruction code from the program memory 4 to the cache 3, a cache designation address designating the cache 3 as the load destination, and a drive circuit for burst transfer from the program memory 4 to the cache 3. When the load control section 15 receives a start-of-transfer signal from the transfer control section 17 in the case of the address comparison section 12 outputting the mismatch signal due to a cache error, burst transfer is performed for storage of the instruction code from the program memory 4 to the cache 3 in accordance with the fetch address from the MPU 2, which is set in the cache start register. The burst transfer is set such that, for example, 8 words are taken from the program memory 4 into the cache 3 with each burst transfer. By performing the burst transfer four times, 32 words are stored in the cache 3. Thereafter, the load control section 15 outputs an end-of-transfer signal instructing the end of the burst transfer to the transfer control section 17. Also, in the case of the output unit 14 outputting the match signal, when the load control section 15 receives the start-of-transfer signal from the transfer control section 17, the burst transfer is performed for storage of the instruction code from the program memory 4 to the cache 3 in accordance with the prefetch address set in the cache start register. Then, the load control section 15 outputs the end-of-transfer signal instructing the end of the burst transfer to the transfer control section 17.

The address conversion section 16 converts the fetch address to an access address of the cache 3 when the address comparison section 12 outputs the match signal representing a cache hit, i.e., indicating that the fetch address is within the range indicated by the address register. As a result, the instruction code is outputted from the cache 3 in such a manner that the instruction code corresponding to the fetch address is stored in a register of the MPU 2.

The transfer control section 17 sets the fetch address or the prefetch address in the cache start register of the load control section 15. Also, the transfer control section 17 designates the cache 3 into which is to be loaded the instruction code from the program memory 4. Further, the transfer control section 17 outputs the start-of-transfer signal to the load control section 15. In an initial state after power-on, the instruction code is stored in the cache 18. Upon receiving an end-of-transfer notice from the load control section 15, the transfer control section 17 determines the cache 3 into which is to be loaded the instruction code. More specifically, the cache other than the cache 3 for which the loading of the instruction code from the program memory 4 into the cache 3 is completed and for which the match signal is outputted from the address comparison section 12 is determined as the load destination cache 3. Thereafter, the transfer control section 17 determines whether the loading from the program memory 4 is started. For example, when the transfer inhibit data is turned on, the transfer is not performed.

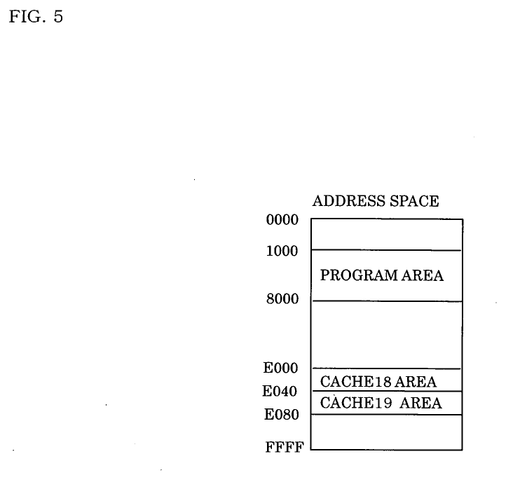

FIG. 5 is an illustration for explaining an address space. In an illustrated example, the address space has addresses “0000- FFFF”. For example, the addresses “1000-7FFF” represent a program area, and “E000-E07F” represent an area of the cache 3. The cache area is divided into two areas, i.e., “E000-E03F” for the cache 18 and “E040-E07F” for the cache 19.

The instruction-code fetching operation of the MPU 2 will be described in brief below. The fetch address for fetching the instruction code is outputted from the MPU 2 to an address bus, to thereby assert a read control signal line. The instruction-code fetch address from the MPU 2 is then compared with the address of the instruction code stored in the cache 3. In other words, the address comparison section 12 checks whether the fetch address is included within the range of the storage address of the instruction code, which is stored in the cache 18 or the cache 19. If the address comparison section 12 outputs the match signal indicating a cache hit as a result of determining that the instruction code at the address designated by the MPU 2 has already been taken into the cache 18 or the cache 19, the address conversion section 16 converts the fetch address from the MPU 2 to a storage address of the cache 18 or the cache 19 and outputs the instruction code to a data bus from the address of the cache 18 or the cache 19 at which the instruction code is stored. The MPU 2 takes in the instruction code on the data bus. With the outputting of the match signal, the address conversion section 16 executes the address conversion as follows. It is here assumed that the fetch address from the MPU 2 is “1010”, and a head address and a final address of the address register are respectively “1000” and “103F”. Because the cache address is “E000”, the address conversion is performed by adding the address “E000” to the difference between the head address and the fetch address, and “E010” is outputted as an address from which is to be fetched the instruction code. On the other hand, if the address comparison section 12 outputs the mismatch signal as a result of determining that the fetch address designated by the MPU 2 is not matched with the range indicated by the address register, the transfer control section 17 sets the outputted fetch address in the cache start register. Also, the transfer control section 17 outputs the start-of-transfer signal to the load control section 15. Then, the load control section 15 decomposes the fetch address into a row address and a column address and outputs a start command, the row address, a read command and the column address to the program memory 4 at respective predetermined timings. As a result, the instruction code is outputted from the program memory 4 in length corresponding to 8 words and is written in the cache 18, for example. Because the cache 18 has a capacity of 64 bytes, the instruction code can be transferred and filled in the cache 18 by repeating the transfer four times. Consequently, in the case of one instruction being constituted by one word, 32 units of instruction code are stored in the cache 18.

The head address of the fetch address is stored in the address registers A and B at the same time as setting of the cache start register. The final address is set while successively updating the address in the address register B each time when the instruction code is transferred from the program memory 4 to the cache 18. After completion of the burst transfer to the cache 18, the instruction code corresponding to the fetch address from the MPU 2 is outputted to the data bus. Then, the MPU 2 takes in the instruction code on the data bus. When the cache 3 as the storage destination of the burst transfer and the cache 3 accessed by the MPU 2 are the same, the MPU 2 can fetch the instruction code in a period between the burst transfers. On the other hand, when the cache 3 as the storage destination of the burst transfer and the cache 3 accessed by the MPU 2 differ from each other, the MPU 2 can fetch the instruction code even during the burst transfer because the program memory 4 and the cache 3 are connected to each other by a local bus.

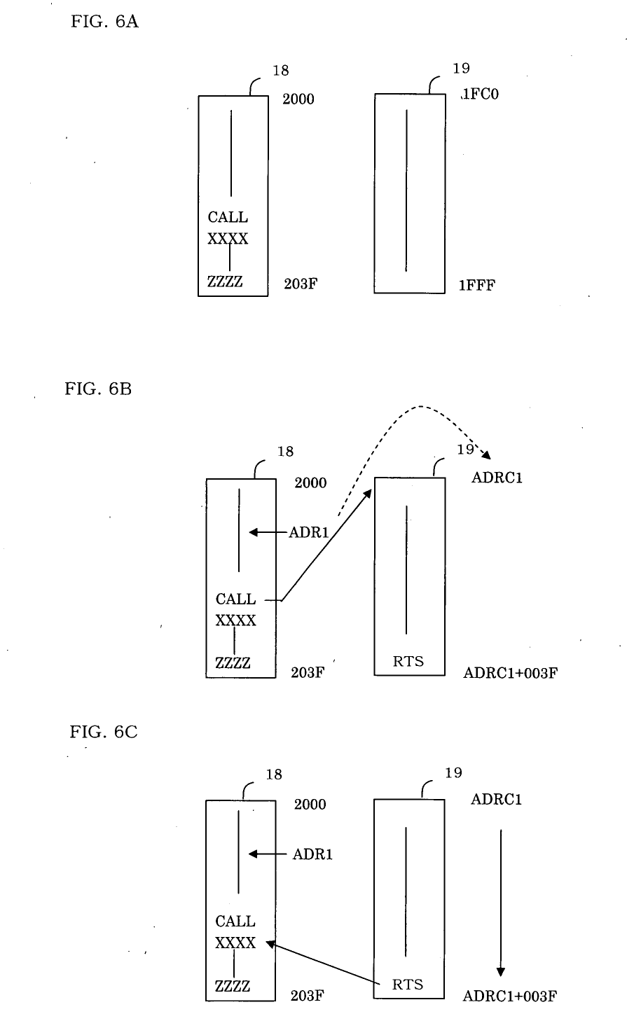

A description is now made of the case where the program includes an unconditional branch instruction. FIGS. 6A-6C are illustrations for explaining, as a first part, a subroutine operation. A correspondence table between the load start address for storage of the subroutine in the cache 3 and the program storage address at which the subroutine is stored is previously registered in the table 13. FIG. 4A shows, by way of example, the correspondence among the load start address ADR1 for storage of the subroutine program in the cache 3, the program storage address ADRC1 in the program memory 4 at which the subroutine program is stored, and the transfer inhibit data “1”. The tables of ADR2 and ADR3 are assumed to be not used. In an illustrated example, a subroutine is called at one point in the program. Additionally, the following conditions are assumed here. First, the program is stored in the cache 18 and the cache 19. A head address and a final address in the address register of the cache 18 at that time are “2000” and “203F”, respectively. The address is expressed in hexadecimal notation. The cache 18 stores a CALL instruction (subroutine call instruction), an XXXX instruction at an address next to the CALL instruction, and a ZZZZ instruction at a final address of the cache 18. Further, a head address and a final address of the cache 19 are respectively “1FC0” and “1FFF” (see FIG. 6A).

The instruction code in the cache 18 is successively accessed in accordance with the fetch address from the MPU 2. Then, the table 13 is accessed in accordance with the fetch address. When the instruction-code fetch address ADR1 from the MPU 2 is inputted to the table 13, the output unit 14 outputs the address ADRC1 corresponding to ADR1 along with the match signal. Upon detecting the match signal, the transfer control section 17 sets ADRC1 in the cache start register. It also sets the cache 19 as the storage destination cache 3. Further, the transfer control section 17 outputs the start-of-transfer signal to the load control section 15. In addition, the transfer control section 17 stores the transfer inhibit data “1”. Responsively, the load control section 15 starts to store the subroutine in the cache 19. Assuming the volume of the subroutine to be 64 bytes, for example, all 64 bytes of the subroutine is loaded in the cache 19 corresponding to the capacity of the cache 19. The instruction code previously stored in the cache 19 is overwritten. The head address ADRC1 of the subroutine is stored in the address register C of the cache 19. The final address in the address register D is “ADRC1+003F” (see FIG. 6B).

Next, the MPU 2 successively executes the instruction code stored in the cache 18. Because the subroutine program being included in the cache 19, when the MPU 2 executes the CALL instruction, the instruction code of the subroutine is taken out of the cache 19 in which is stored the instruction code corresponding to the address ADRC1 as an execution target of the CALL instruction, and is set in the register of the MPU 2. At that time, the transfer control section 17 stores the transfer inhibit data corresponding to ADR1 and therefore does not automatically load the instruction code into the cache 18 from the address “ADRC1+0040” of the program memory 4. When the MPU 2 successively executes the instruction code stored in the cache 19 and executes RTS (subroutine return instruction) at “ADRC1+003F”, the MPU 2 performs the instruction fetch from the address next to the CALL address (see FIG. 6C). Then, access to the cache 18 is started.

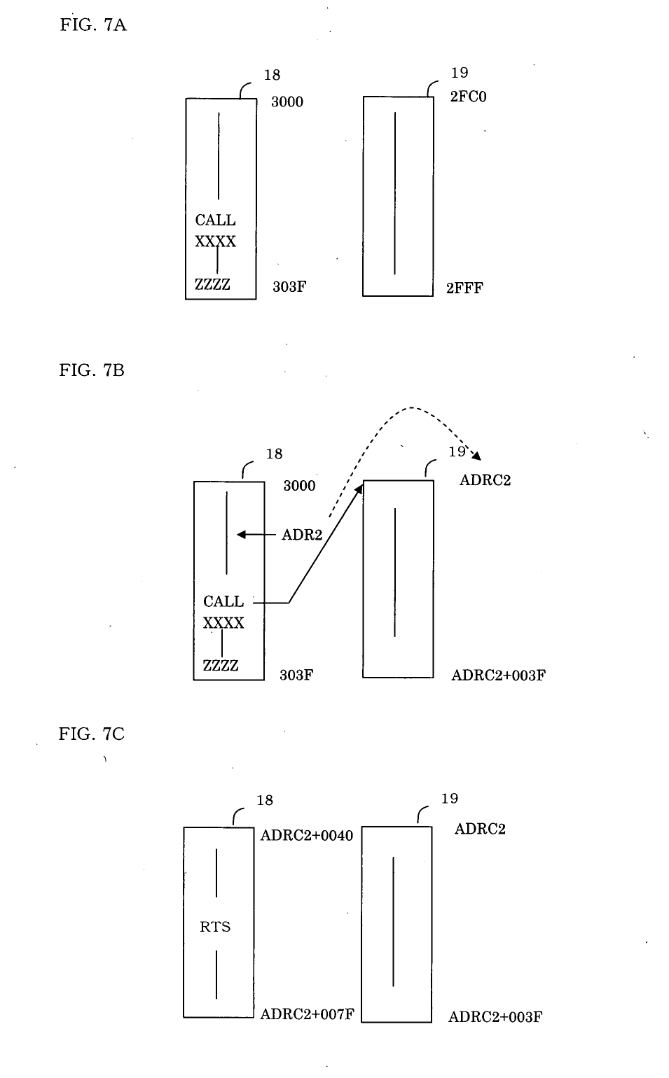

FIGS. 7A-7C are illustrations for explaining, as a second part, the subroutine operation. FIG. 4A shows the correspondence among the load start address ADR2 for storage of the subroutine program in the cache 3, the program storage address ADRC2 in the program memory 4 at which the subroutine program is stored, and the transfer inhibit data “0”. The table of ADR1 is assumed to be not used. In an illustrated example, a subroutine is called at one point in the program. Also, FIG. 4A shows the correspondence among the load start address ADR3 for storage of the program subsequent to the return destination address for the subroutine into the cache, the program storage address ADRR3 in the program memory 4 at which the subroutine return destination address is stored, and the transfer inhibit data “0”. Additionally, the following conditions are assumed here. First, the program is stored in the cache 18 and the cache 19. A head address and a final address in the address register of the cache 18 at that time are “3000” and “303F”, respectively. The address is expressed in hexadecimal notation. The cache 18 stores a CALL instruction, an XXXX instruction at an address next to the CALL instruction, and a ZZZZ instruction at a final address of the cache 18. Further, a head address and a final address of the cache 19 are respectively “2FC0” and “2FFF” (see FIG. 7A).

The instruction code in the cache 18 is successively accessed in accordance with the fetch address from the MPU 2. Then, the table 13 is accessed in accordance with the fetch address. When ADR2 is inputted to the table 13, the output unit 14 outputs the address ADRC2 corresponding to ADR2 along with the match signal. The output unit 14 also outputs the transfer inhibit data “0”. Upon detecting the match signal, the transfer control section 17 sets ADRC2 in the cache start register. It also sets the cache 19 as the storage destination cache 3. Further, the transfer control section 17 outputs the start-of-transfer signal to the load control section 15. Responsively, the load control section 15 starts to store the subroutine in the cache 19. Assuming the volume of the subroutine to be 96 bytes, for example, just 64 bytes of the subroutine is loaded in the cache 19 corresponding to the capacity of the cache 19. The instruction code previously stored in the cache 19 is overwritten. The head address ADRC2 of the subroutine is stored in the address register C of the cache 19. The final address in the address register D is “ADRC2+003F” (see FIG. 7B).

Next, the MPU 2 successively executes the instruction code. Because of the subroutine program being included in the cache 19, when the MPU 2 executes the CALL instruction, the instruction code of the subroutine is taken out of the cache 19 in which is stored the instruction code corresponding to the address ADRC2 as an execution target of the CALL instruction, and is set in the register of the MPU 2. On the other hand, because of the transfer inhibit data being “0”, the transfer control section 17 sets “ADRC2+0040” in the cache start register upon determining that the loading of the subroutine into the cache 19 has been completed and the access to the cache 19 has been started. Also, the transfer control section 17 sets the cache 18 as the storage destination cache 3. Further, the transfer control section 17 outputs the start-of-transfer signal to the load control section 15. As a result, the load control section 15 loads 64 bytes, including the remaining volume (32 bytes) of the subroutine, in the cache 18. The head address ADRC2 of the cache 18 is “ADRC2+0040” (see FIG. 7C). Then, when the instruction-code fetch address for the subroutine reaches the final address “ADRC2+003F”, the MPU 2 outputs the address “ADRC2+0040”. With the comparison executed in the address comparison section 12, therefore, a cache hit occurs for the head address of the cache 18 and the instruction code stored in the cache 18 is outputted.

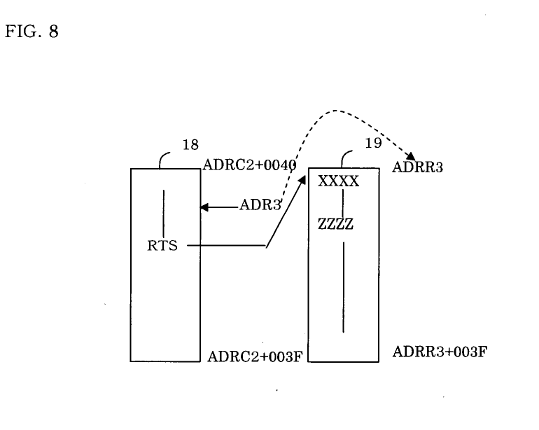

FIG. 8 is an illustration for explaining, as a third part, the subroutine operation. The instruction code in the cache 18 is successively accessed in accordance with the fetch address from the MPU 2. Then, the table 13 is accessed in accordance with the fetch address. When ADR3 is inputted to the table 13, the output unit 14 outputs the address ADRR3 corresponding to ADR3 along with the match signal. Therefore, the transfer control section 17 sets ADRR3 in the cache start register. Further, the transfer control section 17 outputs the start-of-transfer signal to the load control section 15. Responsively, the load control section 15 stores 64 bytes following the address next to the CALL instruction in the cache 19 from the program memory 4. The address ADRR3 next to the CALL instruction is stored in the address registers C and D of the cache 19. In addition, the address in the address register D is successively updated and an address “ADRR3+003F” is stored as the final address therein (see FIG. 8). Then, the MPU 2 successively executes the instruction code. Because of the address next to the CALL instruction being stored in the cache 19, upon executing RTS, the MPU 2 takes out the corresponding instruction code from the cache 19 for execution thereof.

Meanwhile, when the same subroutine is used at a plurality of points in the program, the table of FIG. 4B is employed. With reference to FIGS. 7A-7C and 8, a description is made of primarily processes differing from those described above in connection with the case where the subroutine is called at one point in the program.

FIG. 7B shows an example in which the subroutine program is stored in the cache 19 from the program storage address ADRC2 in the program memory 4 corresponding to the load start address ADR2. First, when the cache 18 is successively accessed in accordance with the fetch address from the MPU 2 and a match with the load start address ADR2 is determined, the prefetch address ADRC2 is outputted and at the same time the subroutine return destination address ADRR3 is stored in the memory B 64 of the output unit 14. Then, the subroutine program is stored in the cache 19 from the program storage address ADRC2 in the program memory 4. Thereafter, the process is advanced and the instruction code in the cache 18 is successively accessed in accordance with the fetch address from the MPU 2 as shown in the example of FIG. 8. When the instruction-code fetch address from the MPU 2 reaches ADR3, the permission data “1” is outputted and ADRR3 is read out of the memory B 64. Further, ADRR3 is outputted as the prefetch address from the output unit 14. As a result, the program is transferred from ADRR3 in the program memory 4 to the cache 19. Then, as shown in the example of FIG. 8, the MPU 2 successively executes the instruction code while accessing the cache 18. Because of the address next to the CALL instruction being stored in the cache 19, upon executing RTS, the MPU 2 can take out the corresponding instruction code from the cache 19 for execution thereof.

Meanwhile, storage of the instruction code into the cache 19 is varied depending on execution of a branch instruction. In some cases, therefore, the cache 3 in which is stored the unconditional branch instruction and the cache indicated by the load start address are separate from each other. If both the caches are separate from each other, the storage of the instruction code into the cache cannot be executed because the contents of the cache 3 storing the unconditional branch instruction are destroyed. For that reason, the load start address is ignored. To detect such a state, when the match signal is outputted from the output unit 14, the transfer control section 17 calculates the difference between the address from the output unit 14 and the final address of the cache 3. If the calculated difference is less than a fixed number of bytes, the start-of-transfer signal is not outputted to cease the prefetch. If the calculated difference is not less than the fixed number of bytes, the start-of-transfer signal is outputted to execute the prefetch. Also, when the load start address is detected during automatic loading into the cache 3, the automatic loading is cancelled and the program at the address corresponding to the load start address is loaded in the cache 3. A jump instruction is another example of the unconditional branch instruction. Further, application of the present invention is not limited to the unconditional branch instruction, and the present invention is also applicable to an instruction including plural jumps to the same address. Thus, since the contents of the cache is updated in advance so as to obtain a cache hit when the unconditional branch instruction is executed, the processing in the MPU 2 can be executed at a high speed. Further, since a cache hit in the microprocessor system is increased, processing capabilities of the microprocessor system and the storage device are improved.

What is claimed is:

1. A cache controller for prefetching an instruction code from a memory and storing the instruction code in a cache for a processor, the cache controller comprising:
an address output section for outputting a prefetch address corresponding to a predetermined address upon an instruction fetch address from the processor being matched with the predetermined address; and
a load control section for loading the instruction code in the cache from the outputted prefetch address.

2. The cache controller according to claim 1, wherein the address output section has a correspondence table between the predetermined address and the prefetch address.

3. The cache controller according to claim 1, wherein the predetermined address has a value smaller than that of a storage address of an unconditional branch instruction by a predetermined value.

4. The cache controller according to claim 1, wherein the predetermined address has a value smaller than that of a storage address of an instruction for return from a subroutine by a predetermined value.

5. The cache controller according to claim 2, wherein the correspondence table stores correspondence between an address having a value smaller than that of a storage address of a subroutine call instruction by a predetermined value and a subroutine start address and correspondence between an address having a value smaller than that of a storage address of an instruction for return from the subroutine and a subroutine return destination address by a predetermined value.

6. A microprocessor system comprising a main memory for storing instruction code, a cache for prefetching the instruction code from the memory and storing the instruction code, and a cache controller for controlling the cache, the cache controller comprising:
an address output section for outputting a prefetch address corresponding to a predetermined address upon an instruction fetch address from the microprocessor being matched with the predetermined address; and
a load control section for loading the instruction code in the cache from the outputted prefetch address.

7. The microprocessor system according to claim 6, wherein the address output section has a correspondence table between the predetermined address and the prefetch address.

8. The microprocessor system according to claim 6, wherein the predetermined address has a value smaller than that of a storage address of an unconditional branch instruction by a predetermined value.

9. The microprocessor system according to claim 6, wherein the predetermined address has a value smaller than that of a storage address of an instruction for return from a subroutine by a predetermined value.

10. The microprocessor system according to claim 7, wherein the correspondence table stores correspondence between an address having a value smaller than that of a storage address of a subroutine call instruction by a predetermined value and a subroutine start address and correspondence between an address having a value smaller than that of a storage address of an instruction for return from the subroutine and a subroutine return destination address by a predetermined value.

11. A storage device for reading or/and writing data from or/and on a recording medium, the storage device comprising a main memory for storing instruction code, a cache for prefetching the instruction code from the memory and storing the instruction code for a processor, and a cache controller for controlling the cache, the cache controller comprising:
an address output section for outputting a prefetch address corresponding to a predetermined address upon an instruction fetch address from the processor being matched with the predetermined address; and
a load control section for loading the instruction, code in the cache from the outputted prefetch address.

12. The storage device according to claim 11, wherein the address output section has a correspondence table between the predetermined address and the prefetch address.

13. The storage device according to claim 11, wherein the predetermined address has a value smaller than that of a storage address of an unconditional branch instruction by a predetermined value.

14. The storage device according to claim 11, wherein the predetermined address has a value smaller than that of a storage address of an instruction for return from a subroutine by a predetermined value.

15. The storage device according to claim 12, wherein the correspondence table stores correspondence between an address having a value smaller than that of a storage address of a subroutine call instruction by a predetermined value and a subroutine start address and correspondence between an address having a value smaller than that of a storage address of an instruction for return from the subroutine by a predetermined value and a subroutine return destination address.
